(19) United States
(12) Patent Application Publication
(10) Pub. No.: US 2012/0284489 A1
(43) Pub. Date: Nov. 8, 2012

(54) Methods and Apparatus for Constant Extension in a Processor

(75) Inventors: Erich James Plondke, Austin, TX (US); Lucian Codrescu, Austin, TX (US); Charles Joseph Tabony, Austin, TX (US); Suresh K. Venkumahanti, Austin, TX (US); Ajay Anant Ingle, Austin, TX (US)

(73) Assignee: QUALCOMM INCORPORATED, San Diego, CA (US)

(21) Appl. No.: 13/155,565

(22) Filed: Jun. 8, 2011

Related U.S. Application Data
(63) Continuation of application No. 13/099,425, filed on May 3, 2011.

(51) Int. Cl. G06F 9/30

(52) U.S. Cl. 712/226; 712/E09.028

(57) ABSTRACT

Programs often require constants that cannot be encoded in a native instruction format, such as 32-bits. To provide an extended constant, an instruction packet is formed with constant extender information and a target instruction. The constant extender information encoded as a constant extender instruction provides a first set of constant bits, such as 26-bits for example, and the target instruction provides a second set of constant bits, such as 6-bits. The first set of constant bits are combined with the second set of constant bits to generate an extended constant for execution of the target instruction. The extended constant may be used as an extended source operand, an extended address for memory access instructions, an extended address for branch type of instructions, and the like. Multiple constant extender instructions may be used together to provide larger constants than can be provided by a single extension instruction.

### FIELD OF THE INVENTION

The present invention relates generally to techniques for extending operand constants in a processing system and, more specifically, to advantageous techniques for encoding and decoding extension information in an instruction stream to extend operand constants in a processor.

### BACKGROUND OF THE INVENTION

Many portable products, such as cell phones, laptop computers, personal digital assistants (PDAs) or the like, incorporate one or more processors executing programs that support communication and multimedia applications. The processors need to operate with high performance and efficiency to support the plurality of computationally intensive functions for such products.

The processors operate by fetching and executing instructions that generally have a format of 32-bits or less. Programs often require the use of large constants, such as 32-bit or larger constants for use in generating addresses or for mathematical functions. However, since instruction formats are 32-bits or less, a single instruction cannot specify a 32-bit constant and the operation on the constant in a single instruction format. Consequently, two or more function instructions are generally used, or specialized constant storage space is implemented in hardware and allocated in the addressing space of the processor. For example, a 32-bit constant could be formed by the use of two move immediate instructions. A first move immediate instruction encoded with a first 16-bit constant specifies the first 16-bit constant to be loaded to a low half-word 16-bit portion of a 32-bit target register. A second move immediate instruction encoded with a second 16-bit constant specifies the second 16-bit constant to be loaded to a high half-word 16-bit portion of the 32-bit target register. After fetching and executing the two move immediate instructions, a 32-bit constant would be available for access from the 32-bit target register. In this approach, two instructions and their associated processor cycles are required to create a 32-bit constant which is stored in one of the limited available registers from a register file as the target register. In an alternative implementation, a 32-bit constant may be loaded from memory through the data cache, for example. Additionally, either of these conventional approaches generates a 32-bit constant and a third instruction is then required to do a specified operation using the large constant. Thus, either of these conventional approaches tends to be costly to implement, impacts performance, increases code density, and tends to increase power usage.

### SUMMARY OF THE DISCLOSURE

Among its several aspects, the present invention recognizes a need for improved implementations supporting constants that are greater in size than can be stored within an instruction format, have a low implementation cost and reduce power usage. In one embodiment, a method comprises determining a program constant to be used as a source operand of a target instruction, wherein the number of bits used to encode the program constant is greater than the number of bits available to specify a constant in the target instruction. The method further comprises splitting the program constant into a first set of bits that fit into a bit field available to specify a constant in the target instruction and a remaining set of bits and encoding the target instruction with the first set of bits and at least one constant extender instruction with the remaining set of bits for inclusion in a program. The method further comprises storing the program to a computer usable medium as a non-transitory computer readable program.

In another embodiment, a method comprises determining a program constant to be used as a source operand for a target instruction as an implied constant. The method further comprises encoding a constant extender instruction with the program constant for inclusion in a program. The method further comprises executing the target instruction with the program constant accessed from the constant extender instruction.

In another embodiment a computer usable medium having non-transitory computer readable program code embodied therein for encoding a constant comprises program code for determining a program constant to be used as a source operand of a target instruction, wherein the number of bits used to encode the program constant is greater than the number of bits available to specify a constant in the target instruction. The computer usable medium further comprises program code for splitting the program constant into a first set of bits that fit into a bit field available to specify a constant in the target instruction and a remaining set of bits and program code for encoding the target instruction with the first set of bits and at least one constant extender instruction with the remaining set of bits for inclusion in a program. The computer usable medium further comprises program code for storing the program to a processor usable medium as a non-transitory processor readable program.

A more complete understanding of the present invention, as well as further features and advantages of the invention, will be apparent from the following Detailed Description and the accompanying drawings.

### BRIEF DESCRIPTION OF THE DRAWINGS

FIG. 1 is a block diagram of an exemplary wireless communication system in which an embodiment of the invention may be advantageously employed;

FIG. 2A illustrates an exemplary move immediate instruction in accordance with an embodiment of the present invention;

FIG. 2B illustrates an exemplary arithmetic logic unit (ALU) instruction in accordance with an embodiment of the present invention;

FIG. 2C illustrates an exemplary memory access instruction in accordance with an embodiment of the present invention;

FIG. 2D illustrates an exemplary function instruction with an implied constant in accordance with an embodiment of the present invention;

FIG. 2E illustrates an exemplary duplex instruction containing two sub-instructions with one of the sub-instruction having an immediate field that is extendable in accordance with an embodiment of the present invention;

FIG. 2F illustrates an exemplary duplex instruction containing two sub-instructions with both sub-instructions having immediate fields that are extendable in accordance with an embodiment of the present invention;

FIG. 3 illustrates an exemplary constant extender instruction having a 32-bit instruction format in accordance with an embodiment of the present invention;

FIG. 4A illustrates an extended 32-bit constant having a constant format in accordance with an embodiment of the present invention;

FIG. 4B illustrates a second extended 32-bit constant having a second constant format in accordance with an embodiment of the present invention

FIG. 5 is a functional block diagram of a processing complex for dispatching and operating on 32-bit or larger constants in accordance with an embodiment of the present invention;

FIG. 6A illustrates a process for extending a constant prior to dispatch and operating on the extended constant in accordance with an embodiment of the present invention;

FIG. 6B illustrates a process for dispatching constant extender instructions, constructing an extended constant after dispatch, and operating on the extended constant in accordance with an embodiment of the present invention;

FIG. 6C illustrates a process for extending a constant associated with a memory access instruction and executing the memory access instruction using the extended constant as a memory address and storing the memory address as specified by the memory access instruction in accordance with an embodiment of the present invention; and

FIG. 7 illustrates a process of encoding a constant in accordance with an embodiment of the present invention.

### DETAILED DESCRIPTION

The present invention will now be described more fully with reference to the accompanying drawings, in which several embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

Computer program code or “program code” for being operated upon or for carrying out operations according to the teachings of the invention may be initially written in a high level programming language such as C, C++, JAVA®, Smalltalk, JavaScript®, Visual Basic®, TSQL, Perl, or in various other programming languages. A program written in one of these languages is compiled to a target processor architecture by converting the high level program code into a native assembler program. Programs for the target processor architecture may also be written directly in the native assembler language. A native assembler program uses instruction mnemonic representations of machine level binary instructions specified in a native instruction format, such as a 32-bit native instruction format. Program code or computer readable medium as used herein refers to machine language code such as object code whose format is understandable by a processor.

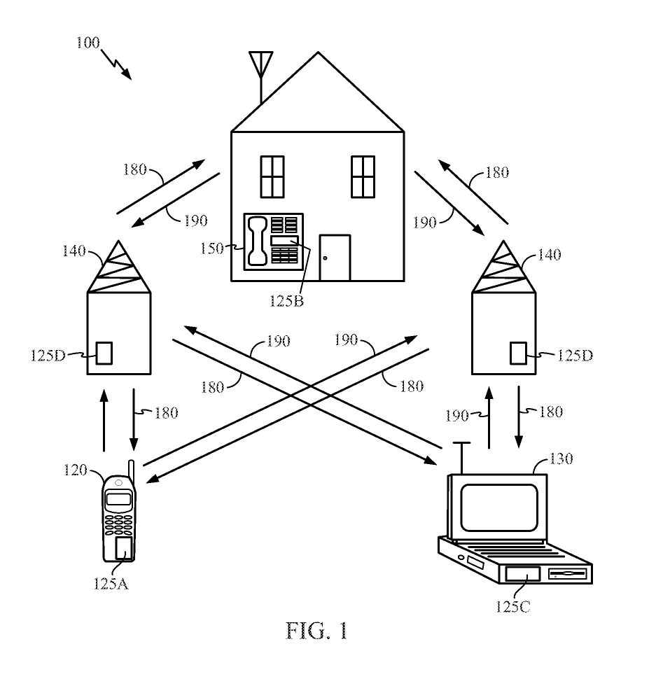

FIG. 1 illustrates an exemplary wireless communication system 100 in which an embodiment of the invention may be advantageously employed. For purposes of illustration, FIG. 1 shows three remote units 120, 130, and 150 and two base stations 140. It will be recognized that common wireless communication systems may have many more remote units and base stations. Remote units 120, 130, 150, and base stations 140 which include hardware components, software components, or both as represented by components 125A, 125C, 125B, and 125D, respectively, have been adapted to embody the invention as discussed further below. FIG. 1 shows forward link signals 180 from the base stations 140 to the remote units 120, 130, and 150 and reverse link signals 190 from the remote units 120, 130, and 150 to the base stations 140.

In FIG. 1, remote unit 120 is shown as a mobile telephone, remote unit 130 is shown as a portable computer, and remote unit 150 is shown as a fixed location remote unit in a wireless local loop system. By way of example, the remote units may alternatively be cell phones, pagers, walkie talkies, handheld personal communication system (PCS) units, portable data units such as personal digital assistants, or fixed location data units such as meter reading equipment. Although FIG. 1 illustrates remote units according to the teachings of the disclosure, the disclosure is not limited to these exemplary illustrated units. Embodiments of the invention may be suitably employed in any processor system supporting programs requiring the use of constants greater in size than can be stored within an instruction format.

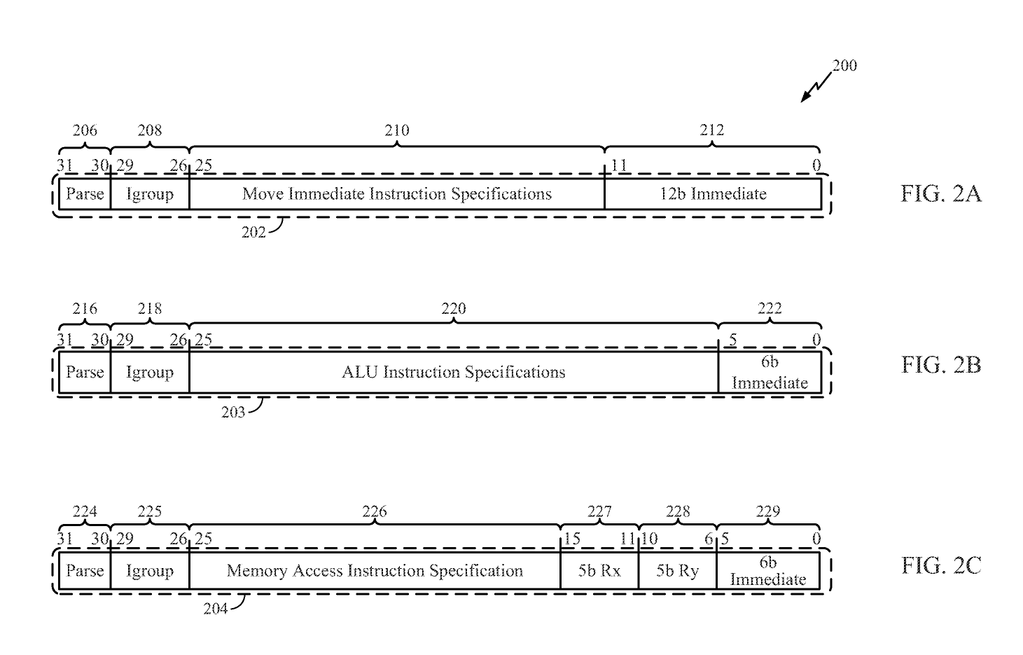

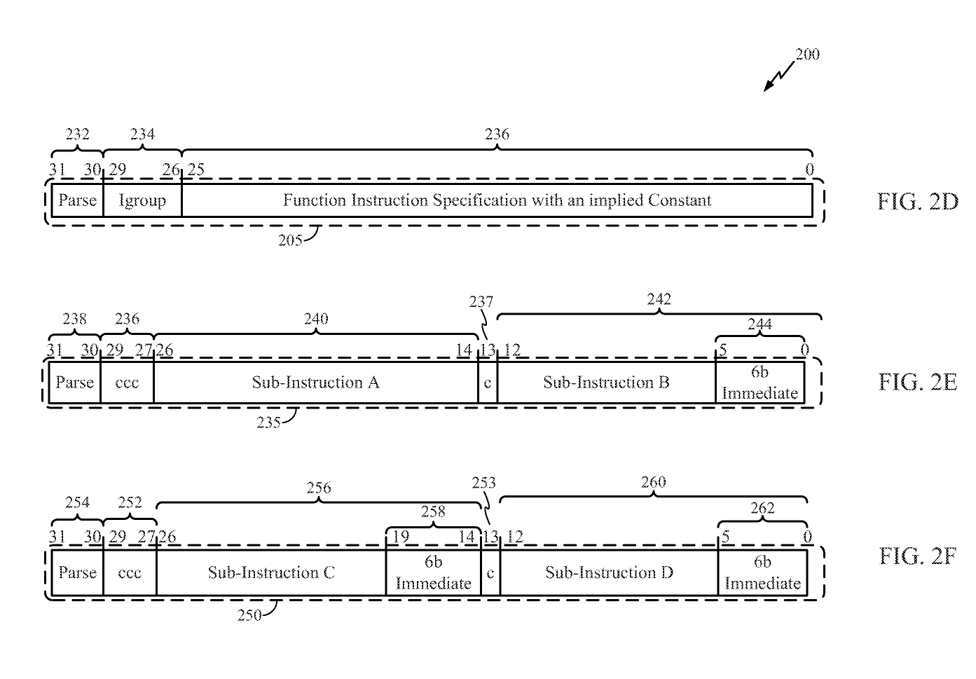

FIG. 2A illustrates an exemplary move immediate instruction 202 in accordance with an embodiment of the present invention. The exemplary move immediate instruction 202 has a parse bit field 206, an instruction group (Igroup) bit field 208, a move immediate instruction specified bit field 210, and a 12-bit immediate field 212. The parse bit field 206 determines the extent of a fetched packet of instructions and may be located in a different position of the instruction than the exemplary one in which it is shown. While a move immediate instruction is shown in FIG. 2A, other instructions, such as memory access instructions and branch type instructions, may use a format similar to the exemplary move immediate instruction 202.

FIG. 2B illustrates an exemplary arithmetic logic unit (ALU) instruction 203 in accordance with an embodiment of the present invention. The exemplary ALU instruction 203 has a parse bit field 216, an instruction group (Igroup) bit field 218, an instruction specified bit field 220, and a 6-bit immediate field 222. The instruction specified bit field 220 is used to specify a type of operation and use of various data types, register source operands, register target operand, and the like.

FIG. 2C illustrates an exemplary memory access instruction 204 in accordance with an embodiment of the present invention. The exemplary memory access instruction 204 illustrates a common instruction format suitable for use by a load instruction or by a store instruction. The exemplary memory access instruction 204 has a parse bit field 224, an instruction group (Igroup) bit field 225, an instruction specification bit field 226, a 5-bit target Rx field 227, a 5-bit Ry field 228, and a 6-bit immediate field 229. The instruction specified bit field 226 is used to specify a type of load or store operation and use of various data types, source operands, target operand, and the like. The 5-bit target Ry field 228 is used to specify a location in a register file for storing an extended constant formed during execution of the memory access instruction 204. The 5-bit Rx field 227 is used to specify a register to store a data value fetched during a load type memory access instruction. Alternatively, the 5-bit Ry field 228 may be used to identify a register holding data to be stored by a store type memory access instruction. While a memory access instruction is shown in FIG. 2C, other instructions, such as function instructions, may use a format similar to the exemplary memory access instruction 204, and store an extended constant formed during execution of the function instruction.

FIG. 2D illustrates an exemplary function instruction 205 with an implied constant in accordance with an embodiment of the present invention. The exemplary function instruction 205 has a parse bit field 232, an instruction group (Igroup) bit field 234, and an instruction specified bit field 236. The instruction specified bit field 236 is used to specify a type of operation with an implied constant. For example, an implied zero constant may be used that could be enhanced with a constant extender to a different number encoded in the constant extender's immediate bit field.

FIG. 2E illustrates an exemplary duplex instruction 235 containing two sub-instructions 240 and 242 with one of the sub-instruction 242 having an immediate field that is extendable in accordance with an embodiment of the present invention. Other aspects of duplex instructions are described in U.S. application Ser. No. 12/716,359 filed Mar. 3, 2010 the details of which are incorporated by reference herein. The exemplary duplex instruction 235 may be considered part of a hierarchical very long instruction word (VLIW) specification where either one sub-instruction, such as sub-instruction A 240 or both sub-instructions may comprise a further partition into sub-sub instructions. The exemplary duplex instruction 235 has a ccc class bit field 236 and a c class bit field 237, a parse bit field 238, a sub-instruction A 240 and a sub-instruction B 242. The ccc class bit field 236 and the c class bit field 237 represent a 4-bit identification group for specifying the type of function for each of the two sub-instructions. The parse bit field 238 may also be used to indicate the presence of the duplex instruction 235 in a fetched packet as well as provide other indications. Sub-instruction 242 includes a 6-bit immediate field 244 that is extendable by use of a constant extender instruction, as described in further detail below.

FIG. 2F illustrates an exemplary duplex instruction 250 containing two sub-instructions with both sub-instructions having immediate fields that are extendable in accordance with an embodiment of the present invention. The exemplary duplex instruction 250 has a ccc class bit field 252 and a c class bit field 253, a parse bit field 254, a sub-instruction C 256 and a sub-instruction D 260. The ccc class bit field 252 and the c class bit field 253 represent a 4-bit identification group for specifying the type of function for each of the two sub-instructions. The parse bit field 254 may also be used to indicate the presence of the duplex instruction 250 in a fetched packet. Sub-instruction C 256 and sub-instruction D 260 both include 6-bit immediate fields 258 and 262, respectively, that are both extendable by use of two constant extender instructions, as described in further detail below.

The parse bit fields 206, 216, 224, 232, 238, and 254 of FIGS. 2A-2F, respectively, may be located in a different position in the instruction based on architecture and implementation requirements, for example. It is also noted that the 6-bit immediate fields 222, 229, 244, 258, and 262 and the 12-bit immediate field 212 are exemplary and may encompass a different number of bits depending on requirements.

FIG. 3 illustrates an exemplary constant extender instruction 300 having a 32-bit native instruction format 302 in accordance with an embodiment of the present invention. The 32-bit native instruction format 302 includes a parse bit field 306, an instruction group (Igroup) bit field 308, and a 26-bit signed immediate bit field 310. The constant extender does not specify an operation to the execution units, but acts as a carrier of extension information to add additional bits to a constant used as a source operand in the target instruction. The constant extender instruction 300 may be associated with the move immediate instruction 202, the ALU instruction 203, and numerous other instructions as specified in an instruction set architecture, such as load, compare, duplex, branch or jump instructions. The constant extender instruction 300 may also be associated with a target instruction that specifies a function of two source operands, one of which is a constant. The target instruction and the constant extender instruction 300 are used to extend the constant and to identify which of the two source operands is to use the extended constant.

The 26-bit immediate bit field 310 is statically determined prior to loading a program. A 32-bit constant may be statically determined by an analysis of a program and then split into a 26-bit segment and a 6-bit segment for use with the ALU instruction 203, for example. The 26-bit segment is specified in the 26-bit immediate bit field 310 of the constant extender native instruction format 302 and the 6-bit segment is specified in the ALU instruction 203.

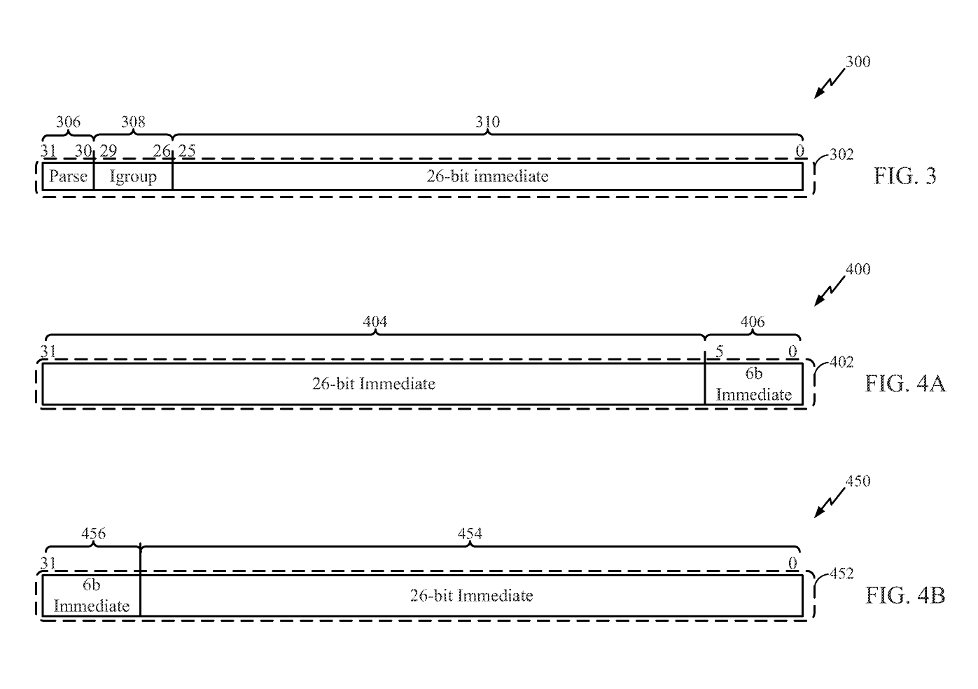

FIG. 4A illustrates an extended 32-bit constant 400 having a constant format 402 in accordance with an embodiment of the present invention. The 6-bit immediate field 406, located in the least significant 6-bits of the 32-bit constant 400, may be directly associated with a 6-bit immediate field, such as the 6-bit immediate field 222 of the ALU instruction 203 and the 6-bit immediate field 229 of the memory access instruction 204. The 6-bit immediate field 406 may also be directly associated with the least significant 6-bits of the 12-bit immediate field 212 of the move immediate instruction 202. The most significant 6-bits of the 12-bit immediate field 212 may be set to zero or treated as don't care bits. Alternatively, the constant format 402 may be modified according to the available immediate field bits from an associated function instruction. For example, with the move immediate instruction 202, the 12-bit immediate field 212 may be used directly as the least significant bits of a 32-bit constant with 20-bits selected from a constant extender instruction to make up the remainder of the 32-bit constant. Such an arrangement could be determined during a decode operation within the processor. The 32-bit constant 400 may be specified as a signed or unsigned 32-bit constant.

FIG. 4B illustrates a second extended 32-bit constant 450 having a second constant format 452 in accordance with an embodiment of the present invention. The 6-bit immediate field 456, located in the most significant 6-bits of the 32-bit constant 450, may be directly associated with the 6-bit immediate field 222 of the ALU instruction 203 or the 6-bit immediate field 229 of the memory access instruction 204. The 6-bit immediate field 456 may also be directly associated with the least significant 6-bits of the 12-bit immediate field 212 of the move immediate instruction 202. The most significant 6-bits of the 12-bit immediate field 212 may be set to zero or treated as don't care bits. Alternatively, the constant format 452 may be modified according to immediate field bits that are available from an associated function instruction. For example, with the move immediate instruction 202, the 12-bit immediate field 212 may be used directly as the most significant bits of a 32-bit constant with 20-bits selected from a constant extender instruction to make up the remainder of the 32-bit constant. Such an arrangement could be determined during a decode operation within the processor. The 32-bit constant 450 may be specified as a signed or unsigned 32-bit constant.

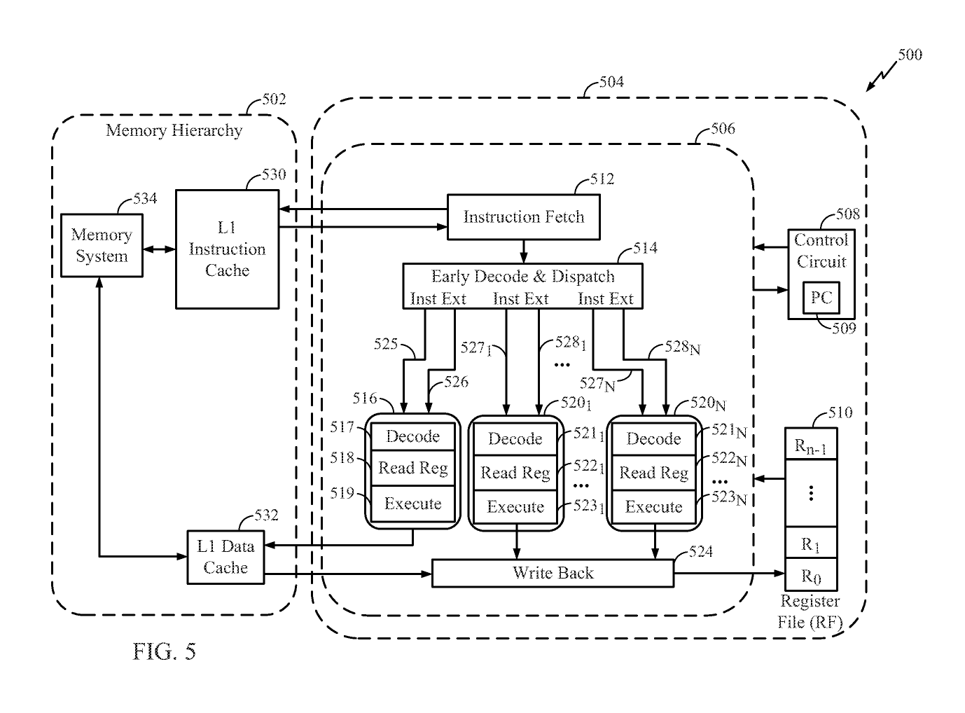

FIG. 5 is a functional block diagram of a processing complex 500 for dispatching and operating on 32-bit or larger constants in accordance with an embodiment of the present invention. The processor complex 500 includes the memory hierarchy 502 and a processor 504 having a processor pipeline 506, a control circuit 508, and a register file (RF) 510. The memory hierarchy 502 includes a level 1 instruction cache (L1 Icache) 530, a level 1 data cache (L1 Dcache) 532, and a memory system 534. The control circuit 508 includes a program counter (PC) 509. Peripheral devices which may connect to the processor complex are not shown for clarity of discussion. The processor complex 500 may be suitably employed in hardware components 125A-125D of FIG. 1 for executing program code that is stored in the L1 Icache 530, utilizing data stored in the L1 Dcache 532 and associated with the memory system 534, which may include higher levels of cache and main memory. The processor 504 may be a general purpose processor, a multi-threaded processor, a digital signal processor (DSP), an application specific processor (ASP) or the like. The various components of the processing complex 500 may be implemented using application specific integrated circuit (ASIC) technology, field programmable gate array (FPGA) technology, or other programmable logic, discrete gate or transistor logic, or any other available technology suitable for an intended application.

The processor pipeline 506 includes, for example, an instruction fetch stage 512, an early decode and dispatch stage 514 having a decode circuit and a dispatch circuit, a memory access unit 516, function execution units 520₁, . . . , 520_{N} and a write back stage 524. The memory access unit 516 is used to execute load and store instructions and has a decode stage 517, a read register (Reg) stage 518, and an execute stage 519. The function execution units 520₁, . . . , 520_{N} each have decode stages 521₁, . . . , 521_{N}, read register stages 522₁, . . . , 522_{N}, and execute stages 523₁, . . . , 523_{N}, respectively. A write back stage 524 writes results to the register file.

Beginning with the first stage of the processor pipeline 506, the instruction fetch stage 512 associated with a program counter (PC) 509, fetches a packet of, for example, four instructions from the L1 Icache 530 for processing by later stages. If an instruction fetch operation misses in the L1 Icache 530, meaning that an instruction to be fetched is not in the L1 Icache 530, the instruction is fetched from the memory system 534 which may include multiple levels of cache, such as a level 2 (L2) cache, and main memory. The instruction fetch stage 512 may also be configured to identify a constant extender in one cache line and a target instruction in a second cache line and combine the two into an instruction packet for decoding by the early decode and dispatch stage 514. Instructions may be loaded to the memory system 534 from other sources, such as a boot read only memory (ROM), a hard drive, an optical disk, or from an external interface, such as a network. Instructions may be fetched in packets of one or more instructions. A constant extender instruction fetched at a first address may be associated with a target instruction specified at the next higher address, for example. The parse field indication in each 32-bit instruction specifies the length of the packet of instructions.

The early decode and dispatch stage 514 receives the packet of up to four instructions from the instruction fetch stage 512. The instructions in the packet are then classified in the early decode and dispatch unit 514 to identify which execution unit or units the instructions should be dispatched to. Fetched instructions in a very long instruction word (VLIW) packet are to be executed in parallel. For example, a branch instruction paired with a constant extender instruction and fetched in a packet could be evaluated and executed together. One type of branch instruction causes a next program counter (pc) value to be generated that is the current pc value plus an immediate offset value located in the branch instruction. The constant extender instruction may be used to extend the offset value. The early decode and dispatch stage uses the instruction group indication to determine which pipeline (516, 520₁, . . . , 520_{N}) will execute each instruction. All instructions specifying operations in the packet may be issued simultaneously to the appropriate execution units for execution. In a scalar machine, a constant extender instruction could be held pending the arrival of the target instruction, at which point both the constant extender and target instructions could be issued in parallel to the specified execution unit, for example.

The early decode operation may be implemented in a parallel process, for example, operating on the fetched plurality of instructions together at a time. For example, with an instruction packet containing four instructions, the first two instructions may be a first constant extender instruction and a move immediate instruction and the next two instructions may be a second constant extender instruction and an arithmetic logic unit (ALU) instruction. In this example, the first constant extender instruction, such as the constant extender instruction 300, is directly associated with the move immediate instruction 202 which is identified as the target instruction. For the move immediate instruction 202, the parse bit field 206 and Igroup bit field 208 are used by the early decode and dispatch stage 514 to identify the destination of the instruction is the function execution unit 520₁. In a first embodiment, the move immediate instruction 202 is dispatched over instruction bus 527₁ and the constant extender instruction 300 is dispatched over extender bus 528₁ to the function execution unit 520₁. In a second embodiment, a 32-bit constant 400 is formed in the early decode and dispatch stage 514 and the target instruction is dispatched over instruction bus 527₁ and the 32-bit constant is dispatched over extender bus 528₁ to the function execution unit 520₁.

Similarly, the second constant extender instruction is directly associated with the ALU instruction 203 which is identified as the target instruction. For example, the parse bit field 216 and Igroup bit field 218 are used by the early decode and dispatch stage 514 to identify the destination of the second instruction as the ALU execution unit 520₂. In the first embodiment, the ALU instruction 203 is dispatched over instruction bus 527₂ and the third instruction encoded using the constant extender native instruction format 302 is dispatched over extender bus 528₂ to the function unit 520₂. In the second embodiment, the ALU instruction 203 is dispatched over the instruction bus 527₂ and a 32-bit constant formed in the early decode and dispatch unit 514 is dispatched over the extender bus 528₂ to the function unit 520₂. It is appreciated that the four instructions in the packet are decoded and dispatched to the function execution unit 520₁ and the function unit 520₂ in parallel. Since architecturally a packet is not limited to four instructions, the early decode and dispatch stage 514 may be extended to operate on more than four instructions in parallel depending on an implementation and an application's requirements.

When the function execution unit 520₁ receives the dispatched information, the first instruction is decoded in decode stage 521₁ to determine the specifics of the move immediate operation and that a 32-bit constant is to be used in the specified operation. In the first embodiment where the move immediate instruction 202 and the constant extender instruction 300 are both dispatched to the function execution unit 520₁, the read register stage 522₁ fetches any data operands required for the specified load operation from the RF 510. The read register stage 522₁ also creates the 32-bit constant for the specified move operation as described above with regards to FIGS. 2A, 3, and 4A. As an alternative, the decode stage 521₁ may create the 32-bit constant for the specified move operation. In the second embodiment where a 32-bit constant 400 is formed in the early decode and dispatch stage 514 and the target instruction and the 32-bit constant are both dispatched to the function execution unit 520₁, no further operation is required to form the 32-bit constant. The execute stage 523₁ executes the dispatched move immediate instruction using the 32-bit constant and the write-back stage 524 writes the result to the RF 510.

When the function unit 520₂ receives the third and fourth instructions, the third instruction is decoded in decode stage 521₂ to determine the specifics of the ALU function and that a 32-bit constant is to be used in the specified operation. In the first embodiment where the ALU instruction 203 and the constant extender instruction 300 are both dispatched to the function execution unit 520₁, the read register stage 522₂ fetches any data operands required for the specified ALU operation from the RF 510. The read register stage 522₂ also creates the 32-bit constant for the specified ALU operation as described above with regards to FIGS. 2B, 3, and 4A. As an alternative, the decode stage 521₂ may create the 32-bit constant for the specified move operation. In the second embodiment where a 32-bit constant 400 is formed in the early decode and dispatch stage 514 and the target instruction and the 32-bit constant are both dispatched to the function execution unit 520₂, no further operation is required to form the 32-bit constant. The execute stage 523₂ executes the dispatched ALU instruction using the 32-bit constant and the write-back stage 524 writes the result to the RF 510 without any delays incurred to create the 32-bit constant.

In another example, a hierarchical VLIW packet containing a constant extender instruction 300 and a target load instruction, having an instruction format such as the memory access instruction 204 of FIG. 2C, may be received in the processor pipeline 506. The parse bit field 224 and Igroup bit field 225 are used by the early decode and dispatch stage 514 to identify that the destination of the target load instruction is the memory access unit 516. In the first embodiment, the target load instruction is dispatched over instruction bus 525 and the constant extender instruction 300 is dispatched over extender bus 526. In the second embodiment, a 32-bit constant 400 representing a memory address is formed in the early decode and dispatch stage 514 and the target load instruction is dispatched over the instruction bus 525 and the 32-bit memory address is dispatched over the extender bus 526 to the memory access unit 516.

When the memory access unit 516 receives the dispatched information, the first instruction is decoded in decode stage 517 to determine the specifics of the load operation and that a 32-bit constant is to be used as an address in the specified operation. In the first embodiment where the memory access instruction 204 and the constant extender instruction 300 are both dispatched to the function execution unit 516, the read register stage 518 may create the 32-bit address for the specified load operation as described above with regards to FIGS. 2C, 3, and 4A. As an alternative, the decode stage 517 may create the 32-bit address for the specified load operation. In the second embodiment where a 32-bit constant 400 is formed in the early decode and dispatch stage 514 and the memory access instruction 204 and the 32-bit constant are both dispatched to the function execution unit 516, no further operation is required to form the 32-bit address. The execute stage 519 executes the dispatched load instruction using the 32-bit address and the write-back stage 524 writes the data fetched from the memory hierarchy 502 to the RF 510 at the address specified in the 5b Rx field 227 and the 32-bit address is written to the target Ry register specified by the 5-bit target Ry field 228.

Embodiments of the present invention may be used to improve processor performance and reduce power. For example, in an implementation without the invention, the following sequence of instructions is generally followed to load a first and second element of an array of data elements:
Load R0 with a 32-bit constant//The 32-bit constant is stored as a separate data element
Load R1 from address in R0/ loads the first data element to R1 from the address in R0
Load R2 from address in R0+4//loads the second data element to R2 from the address in R0+4
   The above sequence comprises three instructions and a 32-bit constant generally stored in the instruction memory. By use of an embodiment of the present invention, the above sequence is transformed to:
Load R1 from (R0=##address)//loads the first data element to R0 from the address formed from a constant extender indicated by ##address syntax and load the formed address to R0
Load R2 from address R0+4//loads the second data element to R2 from the address in R0+4
   The above sequence comprises two instructions and a constant extender generally stored in the instruction memory. Thus, it is possible to save an instruction fetch operation and an instruction memory access operation, which saves power and provides a more compact program.

In another example, a hierarchical VLIW packet of two instructions may be received in the processor pipeline 506. The hierarchical VLIW packet contains a constant extender instruction and a duplex instruction, such as duplex instruction 235 of FIG. 2D having sub-instruction B 242 as the target instruction of the constant extender instruction. Through use of the parse bit field 238, the duplex instruction 235 is identified, for example. Through use of the ccc class bit field 236 and c class bit field 237 in conjunction with the constant extender instruction, the target instruction, sub-instruction 242, and the 6-bit immediate field 244 that is to be extended are identified. Once identified, the 6-bit immediate field 244 is combined with a 26-bit immediate bit field 310 of FIG. 3 of the constant extender instruction to create an extended constant, having a format such as used by the extended 32-bit constant 400 of FIG. 4A or the second extended 32-bit constant 450 of FIG. 4B. Such constant extension may occur in one of the function units 520₁-520_{N} in the first embodiment. In the second embodiment, the constant extension may occur in the early decode and dispatch stage 514.

In a further example, a hierarchical VLIW packet of three instructions may be received in the processor pipeline 506. The hierarchical VLIW packet contains a first constant extender instruction, a second constant extender instruction, and a duplex instruction, such as duplex instruction 250 of FIG. 2E. The duplex instruction 250 comprises sub-instruction C 256 as the target instruction of the first constant extender instruction and sub-instruction D 260 as the target instruction of the second constant extender instruction. Through use of the parse bit field 254, the duplex instruction 250 is identified, for example. Through use of the ccc class bit field 252 and c class bit field 253 in conjunction with the two constant extender instruction, the target instructions are identified. For example, the sub-instruction 256 and the 6-bit immediate field 258 that is to be extended by the first constant extender instruction are identified. Similarly, the sub-instruction 260 and the 6-bit immediate field 262 that is to be extended by the second constant extender instruction are identified. Once identified, the 6-bit immediate field 258 is combined with a 26-bit immediate bit field 310 of FIG. 3 of the first constant extender instruction to create a first extended constant. Similarly, the 6-bit immediate field 262 is combined with a 26-bit immediate bit field 310 of the second constant extender instruction to create a second extended constant. Both the first and second extended constants are formatted, using the extended 32-bit constant format 402 of FIG. 4A or the second extended 32-bit constant format 452 of FIG. 4B. Such constant extensions may occur in sequential order in one function unit or in parallel in multiple of the function units 520₁-520_{N} in the first embodiment. In the second embodiment, the constant extensions may occur sequentially or in parallel in the early decode and dispatch stage 514.

The processor complex 500 may be configured to execute instructions under control of a program stored on a computer readable storage medium. For example, a computer readable storage medium may be either directly associated locally with the processor complex 500, such as may be available from the L1 Icache 530, for operation on data obtained from the L1 Dcache 532, and the memory system 534 or through, for example, an input/output interface (not shown).

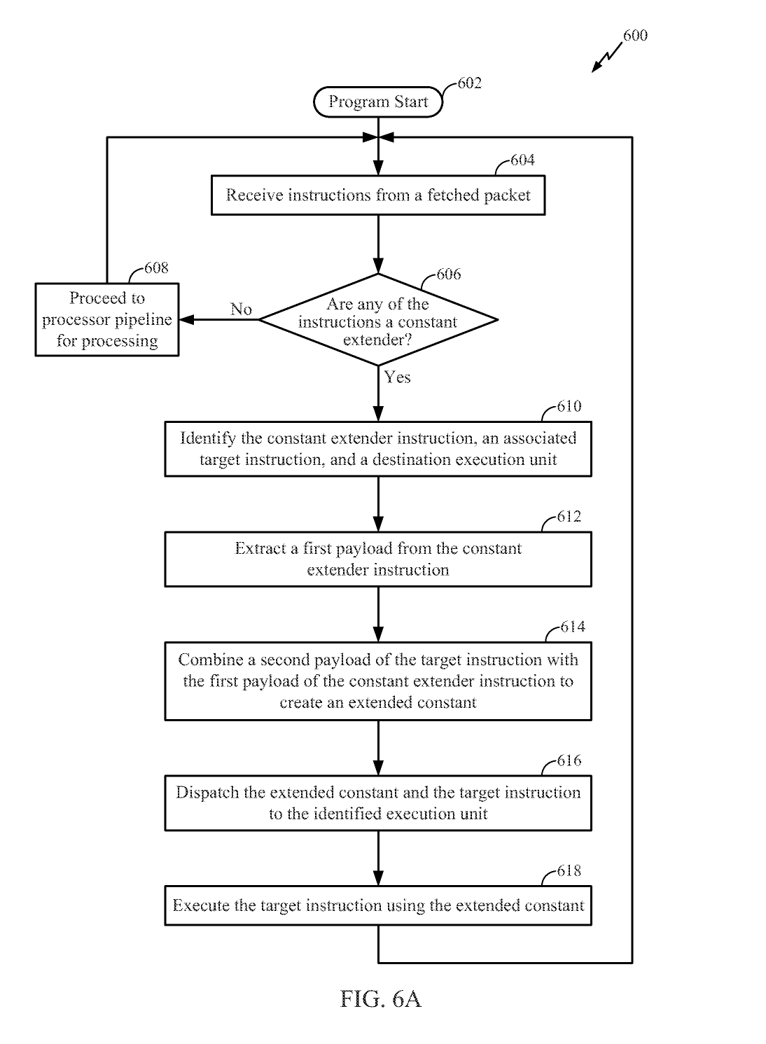

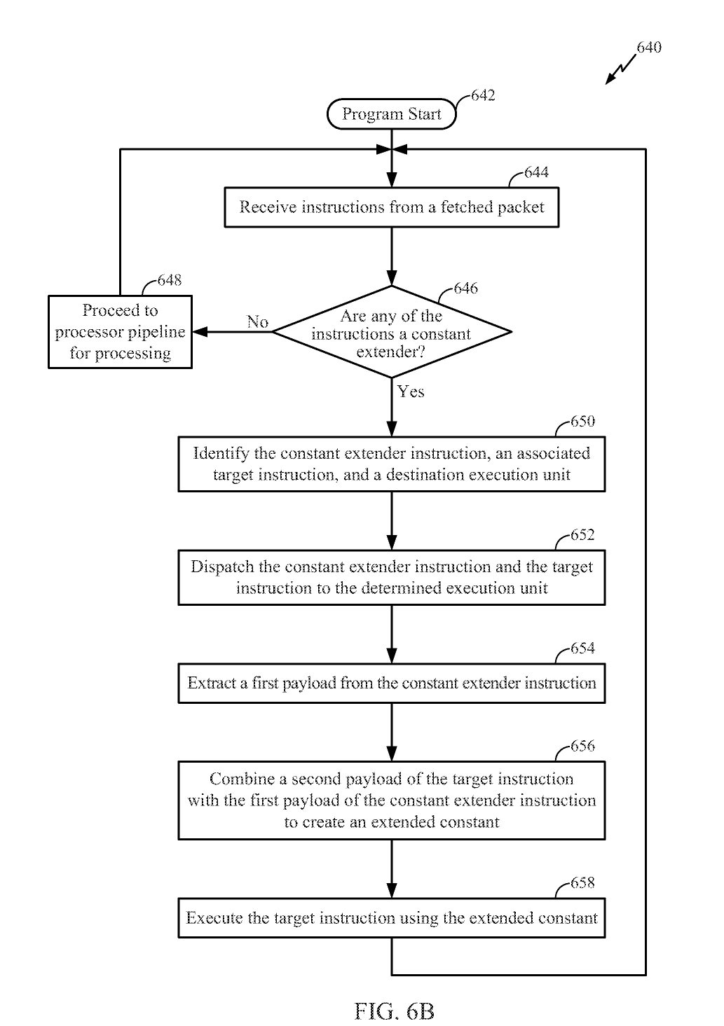

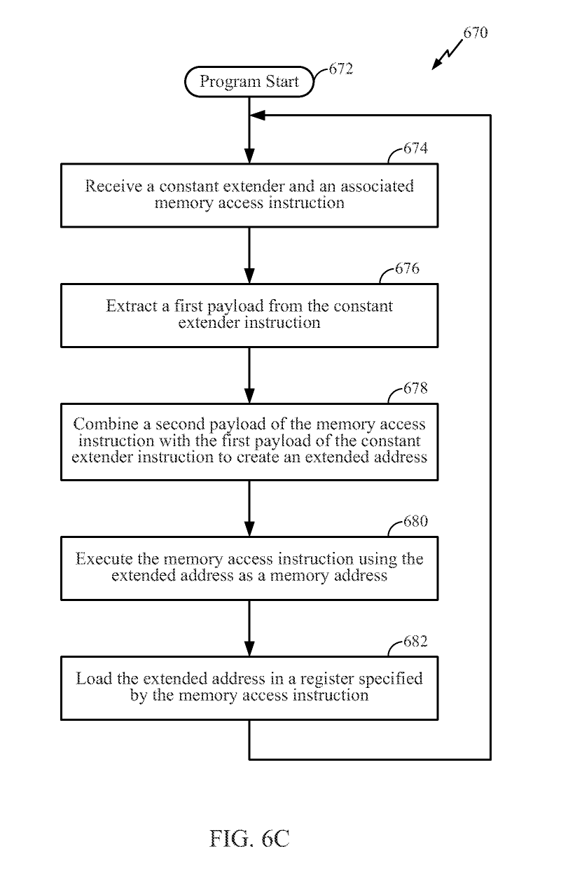

FIG. 6A illustrates a process 600 for extending a constant prior to dispatch and operating on the extended constant in accordance with an embodiment of the present invention. References to previous figures are made to emphasize and make clear implementation details, and not as limiting the process to those specific details. At block 602, a program is started on the processing complex 500. The process 600 follows constant extension operations in the processor pipeline 506.

At block 604, a plurality of instructions is received from a fetched packet, such as a four instruction packet fetched from the L1 Icache 530. At decision block 606, a determination is made whether any instruction of the packet is a constant extender instruction. Such a determination may be made in the early decode and dispatch stage 514. If the determination is negative, the process 600 proceeds to block 608 for processing the four instruction packet in the processor pipeline. If the determination is positive, the process 600 proceeds to block 610. At block 610, the constant extender, a target instruction, and a destination execution unit are identified, for example, in the early decode and dispatch stage 514. By convention, for example, a target instruction may be positioned adjacent to its associated constant extender instruction, either at a lower address than the constant extender instruction or at a higher address than the constant extender instruction. It is also appreciated, for example, that identification means may be provided to locate both a constant extender instruction and a target instruction which may not be adjacent within a fetched plurality of instructions. Also, a target instruction may be a sub-instruction of a duplex instruction, such as the duplex instruction 235 with sub-instruction 242 as a single target instruction. With two constant extender instructions in a fetched packet, the target instructions may be located in an adjacent duplex instruction, such as the duplex instruction 250 with sub-instructions 256 and 260, each a target instruction of one of the constant extender instructions.

At block 612, a first payload, such as a 26-bit immediate field, is extracted from the constant extender instruction, for example, in the early decode and dispatch stage 514. If two constant extender instructions are present, another 26-bit immediate field would be extracted from the second constant extender instruction. At block 614, a second payload, such as the 6-bit field 222, of the target instruction is combined with the first payload of the constant extender instruction to create an extended constant, such as a 32-bit constant. Similarly, if two constant extender instructions are present, another 32-bit constant would be created. Such a combining operation may be made in the early decode and dispatch stage 514. At block 616, the extended constant and the target instruction are dispatched to the identified execution unit on associated identified dispatch paths. If a second 32-bit constant was created, the second 32-bit constant and its associated target instruction would also be dispatched to the appropriate execution unit. At block 618, the target instruction is executed using the extended constant. With two extended constants and two target instructions, two execution units may each receive one of the extended constants and target instructions for parallel execution. Alternatively, a single execution unit may receive both of the extended constants and target instructions and may execute the two target instructions in parallel or sequentially, depending upon available resources for receiving and executing both extended constants and target instructions. For some types of a target instruction, such as a load instruction, the 32-bit constant is interpreted as an address and, for the processing complex 500, there is one memory access unit 516 which executes the load instruction using the 32-bit extended address. The process 600 then returns to block 604.

FIG. 6B illustrates a process 640 for dispatching constant extender instructions, constructing an extended constant after dispatch, and operating on the extended constant in accordance with an embodiment of the present invention. References to previous figures are made to emphasize and make clear implementation details. At block 642, a program is started on the processing complex 500. The process 640 follows the path of one instruction and a constant extender instruction as they flow through the processor pipeline 506.

At block 644, a plurality of instructions is received from a fetched packet, such as a four instruction packet fetched from the L1 Icache 530. At decision block 646, a determination is made whether any instruction of the packet is a constant extender instruction. Such a determination may be made in the early decode and dispatch stage 514. If the determination is negative, the process 640 proceeds to block 648 for processing the four instruction packet in the processor pipeline. If the determination is positive, the process 640 proceeds to block 650. At block 650, the constant extender instruction, an associated target instruction, and a destination execution unit are identified. If two constant extender instructions and two target instructions are present, both are identified at block 650. At block 652, the constant extender and target instructions are dispatched to the identified execution unit, such as function unit 520₁ on associated identified dispatch paths. With two extension operations to be processed, two execution units may each receive one of the constant extender instructions and one of the target instructions. Alternatively, a single execution unit may receive both. At block 654, a first payload, such as the 26-bit immediate field 310, is extracted from the constant extender instruction. At block 656, a second payload, such as the 6-bit immediate field 222, of the target instruction is combined with the first payload of the constant extender instruction to create an extended constant, such as a 32-bit constant. With two extension operations, a second 32-bit constant may be formed in a similar method to that used in blocks 654 and 656. Such a combining operation may be made, for example in the read register stage 522₁. At block 658, the target instruction is executed using the 32-bit constant, for example in the execution stage 523₁. With two target instructions and extended constants, both may be executed in parallel or sequentially, depending upon available resources for receiving and executing both extended constants and target instructions. The process 640 then returns to block 644.

FIG. 6C illustrates a process 670 for extending a constant associated with a memory access instruction and executing the memory access instruction using the extended constant as a memory address and storing the memory address as specified by the memory access instruction. References to previous figures are made to emphasize and make clear implementation details. At block 672, a program is started on the processing complex 500. The process 670 follows one memory access instruction and a constant extender instruction in the processor pipeline 506.

At block 674, a constant extender instruction and an associated memory access instruction are received in the memory access unit 516. At block 676, a first payload, such as the 26-bit immediate field 310, is extracted from the constant extender instruction. At block 678, a second payload, such as the 6-bit immediate field 229, of the memory access instruction is combined with the first payload of the constant extender instruction to create an extended address, such as a 32-bit address. Such a combining operation may be made, for example, in the decode stage 517 or in the read register stage 518. At block 680, the memory access instruction is executed using the 32-bit address as the memory address to load a data element from memory to register Rx specified in the 5b Rx field 227 of the memory access instruction. At block 682, the 32-bit address is written to the Ry register as specified by the 5-bit target Ry field 228. The process 670 then returns to block 674.

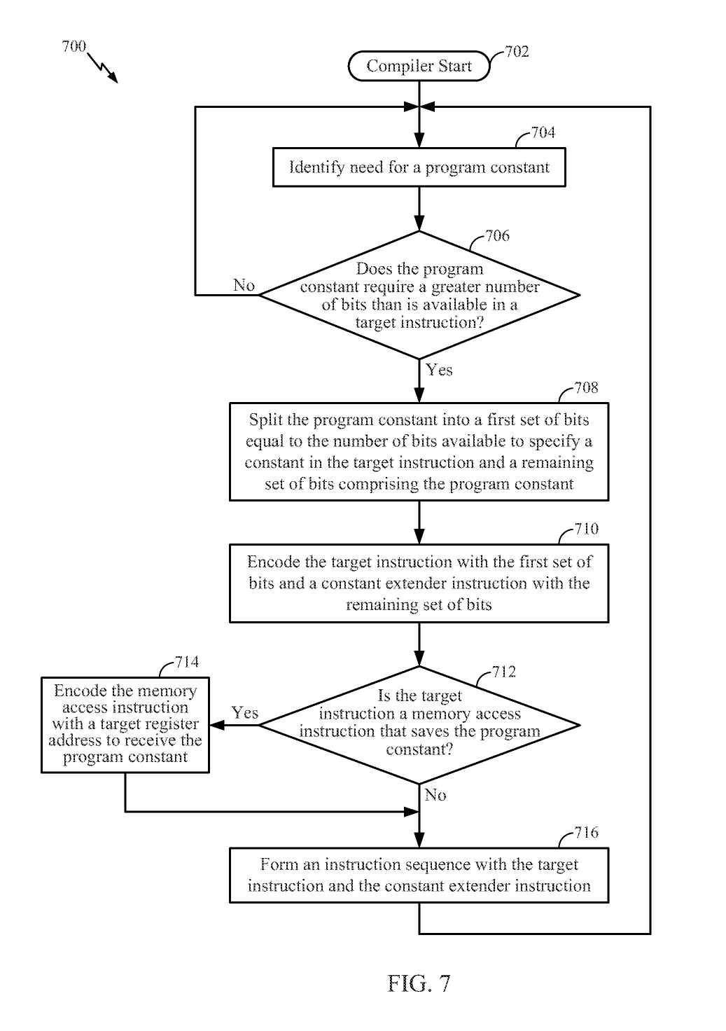

FIG. 7 illustrates a process 700 of encoding a constant in accordance with an embodiment of the present invention. At block 702, a compiler or other such programming tool, starts the evaluation and compilation of a program. At block 704, a need for a program constant is identified. At block 706, a determination is made whether the program constant requires a greater number of bits than is available in a target instruction. If the number of bits available in the target instruction is sufficient to encode the required program constant, the process 700 proceeds to block 704. If the number of bits available in the target instruction is not sufficient to encode the required program constant, the process 700 proceeds to bock 708. At block 708, the program constant is split into a first set of bits equal to the number of bits available to specify a constant in the target instruction and a remaining set of bits comprising the program constant. At block 710, the target instruction is encoded with the first set of bits and a constant extender instruction is encoded with the remaining set of bits. At decision block 712, a determination is made whether the target instruction is a memory access instruction that saves the program constant formed from the first set of bits combined with the remaining set of bits during execution of the memory access instruction. If the target instruction is such a memory access instruction, the process 700 proceeds to block 714. At block 714, the memory access instruction is encoded with a target register address that is to receive the program constant. If the target instruction is not such a memory access instruction, the process 700 proceeds to block 716. At block 716, an instruction sequence, such as an instruction packet, may be formed having the target instruction and the constant extender instruction. By convention, for example, a target instruction may be positioned adjacent to its associated constant extender instruction, either at a lower address than the constant extender instruction or at a higher address than the constant extender instruction. It is also appreciated, for example, that identification means may be provided to locate both a constant extender instruction and a target instruction which may not be adjacent within a fetched plurality of instructions. Also, a target instruction may be a sub-instruction of a duplex instruction, such as the duplex instruction 235 with sub-instruction 242 as a single target instruction. Such an instruction sequence may be included in a program for execution. The process 700 then returns to block 704.

The methods described in connection with the embodiments disclosed herein may be embodied in a combination of hardware and in a software module storing non-transitory signals executed by a processor. The software module may reside in random access memory (RAM), flash memory, read only memory (ROM), electrically programmable read only memory (EPROM), hard disk, a removable disk, tape, compact disk read only memory (CD-ROM), or any other form of storage medium known in the art. A storage medium may be coupled to the processor such that the processor can read information from, and in some cases write information to, the storage medium. The storage medium coupling to the processor may be a direct coupling integral to a circuit implementation or may utilize one or more interfaces, supporting direct accesses or data streaming using down loading techniques.

While the invention is disclosed in the context of illustrated embodiments for use in processor systems it will be recognized that a wide variety of implementations may be employed by persons of ordinary skill in the art consistent with the above discussion and the claims which follow below. For example, constants larger than 32-bits may be created by using two constant extender instructions. For example, a 58-bit constant may be created by combining two 26-bit immediate fields from each constant extender instruction with a constant field in a target instruction. With three or more constant extender instructions, larger constants may be created, for example 84-bit or larger extended constants may be created.

What is claimed is:

1. A method comprising:
determining a program constant to be used as a source operand of a target instruction, wherein the number of bits used to encode the program constant is greater than the number of bits available to specify a constant in the target instruction;
splitting the program constant into a first set of bits that fit into a bit field available to specify a constant in the target instruction and a remaining set of bits;
encoding the target instruction with the first set of bits and at least one constant extender instruction with the remaining set of bits for inclusion in a program; and
storing the program to a computer usable medium as a non-transitory computer readable program.

2. The method of claim 1, wherein encoding further comprises:
encoding a target register field in the target instruction to identify a register where the program constant is to be stored.

3. The method of claim 1, wherein encoding further comprises:
forming an instruction packet with the at least one constant extender instruction and the target instruction.

4. The method of claim 1, wherein encoding further comprises:
forming an instruction packet with the target instruction adjacent to the at least one constant extender instruction.

5. The method of claim 4, wherein the target instruction is positioned in the instruction packet at a lower address than the at least one constant extender instruction.

6. The method of claim 4, wherein the target instruction is positioned in the instruction packet at a higher address than the at least one constant extender instruction.

7. The method of claim 1, wherein encoding further comprises:
encoding the target instruction to indicate a location of the at least one constant extender instruction in an instruction packet.

8. The method of claim 1, wherein the first set of bits is less than the number of bits available to specify a constant in the target instruction and the number of bits used to encode the program constant is equal to the number of bits in a native instruction format.

9. The method of claim 1, wherein the first set of bits concatenated with the remaining set of bits is equal to the number of bits in a native instruction format.

10. The method of claim 1, further comprising:
determining the remaining set of bits is greater than the number of bits available to specify a constant in the at least one constant extender instruction;
splitting the remaining set of bits into a second set of bits that fit into a bit field available to specify the constant in the at least one constant extender instruction and a second remaining set of bits; and
encoding the at least one constant extender instruction with the second set of bits and a second constant extender instruction with the second remaining set of bits for inclusion in the program.

11. The method of claim 1, further comprising:
loading the non-transitory computer readable program to a processor memory;
fetching the target instruction and the at least one constant extender instruction from the processor memory; and
executing the target instruction with the program constant formed from a combination of the first set of bits with the remaining bits.

12. The method of claim 10, wherein executing further comprises:
accessing the first set of bits from the target instruction and the remaining bits from the at least one constant extender instruction to form the program constant; and
identifying the program constant as a source operand based on information contained in the target instruction.

13. A method comprising:
determining a program constant to be used as a source operand for a target instruction as an implied constant;
encoding a constant extender instruction with the program constant for inclusion in a program; and
executing the target instruction with the program constant accessed from the constant extender instruction.

14. The method of claim 13, wherein the target instruction specifies an implied zero constant which is replaced by the program constant.

15. The method of claim 13, wherein the target instruction is positioned in the instruction sequence at a lower address than the constant extender instruction.

16. The method of claim 13, wherein the target instruction is positioned in the instruction sequence at a higher address than the constant extender instruction.

17. A computer usable medium having non-transitory computer readable program code embodied therein for encoding a constant, comprising:
program code for determining a program constant to be used as a source operand of a target instruction, wherein the number of bits used to encode the program constant is greater than the number of bits available to specify a constant in the target instruction;
program code for splitting the program constant into a first set of bits that fit into a bit field available to specify a constant in the target instruction and a remaining set of bits;
program code for encoding the target instruction with the first set of bits and at least one constant extender instruction with the remaining set of bits for inclusion in a program; and
program code for storing the program to a processor usable medium as a non-transitory processor readable program.

18. The computer usable medium of claim 17, further comprising:
program code for loading the non-transitory processor readable program to a processor memory coupled to the computer usable medium;
fetching the target instruction and the at least one constant extender instruction from the processor memory; and
executing the target instruction with the program constant formed from a combination of the first set of bits with the remaining bits.

19. The computer usable medium of claim 17, wherein the program code for encoding further comprises:
program code for forming an instruction packet with the target instruction adjacent to the at least one constant extender instruction.

20. The computer usable medium of claim 17, wherein the first set of bits is less than the number of bits available to specify a constant in the target instruction and the number of bits used to encode the program constant is equal to the number of bits in a native instruction format.

21. The computer usable medium of claim 17, wherein the first set of bits concatenated with the remaining set of bits is equal to the number of bits in a native instruction format.

22. The computer usable medium of claim 17, wherein the program code for encoding further comprises:
program code for encoding a target register field in the target instruction to identify a register where the program constant is to be stored.
